(19) United States
(12) Patent Application Publication
(10) Pub. No.: US 2026/0004720 A1
(43) Pub. Date: Jan. 1, 2026

(54) DISPLAY APPARATUS AND ELECTRONIC APPARATUS INCLUDING THE SAME

(71) Applicant: Samsung Display Co., LTD., Yongin-si (KR)

(72) Inventors: GARAM KIM, Yongin-si (KR); HUN-BAE KIM, Yongin-si (KR); KWANGSUB SHIN, Yongin-si (KR)

(21) Appl. No.: 19/220,558

(22) Filed: May 28, 2025

(30) Foreign Application Priority Data
Jun. 28, 2024 (KR) 10-2024-0085609

(51) Int. Cl. G09G 3/32

(52) U.S. Cl. CPC G09G 3/32; G09G 2300/043; G09G 2300/0819; G09G 2310/08; G09G 2320/0233; G09G 2330/021

(57) ABSTRACT

A display apparatus includes a display panel and a display panel driver. The display panel includes a pixel including a light-emitting element and a driving switching element. The display panel driver determines an image transition of a display image of the display panel and changes a voltage applied to the driving switching element in a frame after the image transition when the image transition occurs.

This application claims priority to Korean Patent Application No. 10-2024-0085609, filed on Jun. 28, 2024, and all the benefits accruing therefrom under 35 U.S.C. § 119, the content of which in its entirety is herein incorporated by reference.

### BACKGROUND

### 1. Field

Embodiments of the inventive concept relate to a display apparatus and an electronic apparatus including the display apparatus. More particularly, embodiments of the inventive concept relate to a display apparatus enhancing a display quality and reducing a power consumption and an electronic apparatus including the display apparatus.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver, a data driver, an emission driver and a driving controller. The gate driver outputs gate signals to the gate lines. The data driver outputs data voltages to the data lines. The emission driver outputs emission signals to the emission lines. The driving controller controls an operation of the gate driver, an operation of the data driver and an operation of the emission driver.

A threshold voltage of a driving switching element of the display panel when a display image is changed from a low grayscale image to a high grayscale image may be different from a threshold voltage of the driving switching element when the display image is changed from the high grayscale image to the low grayscale image. This characteristic may be referred to as a hysteresis characteristic of the driving switching element.

Due to the hysteresis characteristic of the driving switching element, a luminance of the display image may be lower than a desired luminance in a first frame when the display image is changed from the low grayscale image to the high grayscale image.

### SUMMARY

In a conventional display apparatus, an initialization operation of the driving switching element and a threshold voltage compensation operation of the driving switching element are repetitively performed to compensate the hysteresis characteristic of the driving switching element.

However, when the initialization operation of the driving switching element and the threshold voltage compensation operation of the driving switching element are repetitively performed, a power consumption may be increased and a luminance deviation may occur according to a driving frequency in a variable frequency driving method.

Embodiments of the inventive concept provide a display apparatus enhancing a display quality and reducing a power consumption by changing a voltage applied to a driving switching element to compensate a hysteresis characteristic of the driving switching element.

Embodiments of the inventive concept also provide an electronic apparatus including the display apparatus.

In an embodiment of a display apparatus according to the inventive concept, the display apparatus includes a display panel and a display panel driver. The display panel includes a pixel including a light-emitting element and a driving switching element. The display panel driver determines an image transition of a display image of the display panel and changes a voltage applied to the driving switching element in a frame after the image transition in a state in which the image transition occurs.

In an embodiment, the driving switching element may include a control electrode connected to a first node, a first electrode connected to a second node and a second electrode connected to a third node. The pixel may further include a writing switching element including a control electrode which receives a writing gate signal, a first electrode which receives a data voltage and a second electrode connected to the second node and a bias switching element including a control electrode which receives a bias gate signal, a first electrode which receives a bias voltage and a second electrode connected to the second node. The display panel driver may increase the bias voltage applied to the first electrode of the driving switching element in the frame after the image transition.

In an embodiment, the display panel driver may increase the bias voltage applied to the first electrode of the driving switching element in one frame after the image transition.

In an embodiment, the display panel driver may increase the bias voltage applied to the first electrode of the driving switching element in plural consecutive frames after the image transition.

In an embodiment, a first increase of the bias voltage in a first frame after the image transition may be greater than a second increase of the bias voltage in a second frame after the image transition.

In an embodiment, the pixel may further include a data initialization switching element including a control electrode which receives a data initialization gate signal, a first electrode which receives a data initialization voltage and a second electrode connected to a control electrode of the driving switching element. The display panel driver may decrease the data initialization voltage applied to the control electrode of the driving switching element in the frame after the image transition.

In an embodiment, the display panel driver may decrease the data initialization voltage applied to the control electrode of the driving switching element in one frame after the image transition.

In an embodiment, the display panel driver may decrease the data initialization voltage applied to the control electrode of the driving switching element in plural consecutive frames after the image transition.

In an embodiment, a first decrease of the data initialization voltage in a first frame after the image transition may be greater than a second decrease of the data initialization voltage in a second frame after the image transition.

In an embodiment, the driving switching element may include a P-type transistor. The pixel may further include a data initialization switching element including an N-type transistor.

In an embodiment, the driving switching element may include a control electrode connected to a first node, a first electrode connected to a second node and a second electrode connected to a third node. The pixel may further include a writing switching element including a control electrode which receives a writing gate signal, a first electrode which receives a data voltage and a second electrode connected to the second node, a bias switching element including a control electrode which receives a bias gate signal, a first electrode which receives a bias voltage and a second electrode connected to the second node and a data initialization switching element including a control electrode which receives a data initialization gate signal, a first electrode which receives a data initialization voltage and a second electrode connected to the first node. The display panel driver may increase the bias voltage applied to the first electrode of the driving switching element and decrease the data initialization voltage applied to the control electrode of the driving switching element in the frame after the image transition.

In an embodiment, the display panel driver may increase the bias voltage applied to the first electrode of the driving switching element and decrease the data initialization voltage applied to the control electrode of the driving switching element in one frame after the image transition.

In an embodiment, the display panel driver may increase the bias voltage applied to the first electrode of the driving switching element and decrease the data initialization voltage applied to the control electrode of the driving switching element in plural consecutive frames after the image transition.

In an embodiment, a first increase of the bias voltage in a first frame after the image transition may be greater than a second increase of the bias voltage in a second frame after the image transition. A first decrease of the data initialization voltage in the first frame after the image transition may be greater than a second decrease of the data initialization voltage in the second frame after the image transition.

In an embodiment, the pixel is provided in plural, and the voltage applied to the driving switching element and changed in the frame after the image transition may be commonly applied to all of pixels of the display panel.

In an embodiment, the voltage applied to the driving switching element and changed in the frame after the image transition may be independently applied in a unit of a pixel row of the display panel.

In an embodiment, the voltage applied to the driving switching element and changed in the frame after the image transition may be independently applied in a unit of the pixel of the display panel.

In an embodiment, in a state in which the display panel driver receives an updated image, the display panel driver may determine the image transition.

In an embodiment, the display panel driver may determine the image transition by comparing a previous frame image and a current frame image.

In an embodiment of an electronic apparatus according to the inventive concept, the electronic apparatus includes a display panel, a display panel driver and a processor. The display panel includes a pixel including a light-emitting element and a driving switching element. The display panel driver determines an image transition of a display image of the display panel and which changes a voltage applied to the driving switching element in a frame after the image transition in a state in which the image transition occurs. The processor outputs input image data and an input control signal to the display panel driver.

According to the display apparatus and the electronic apparatus including the display apparatus, the voltage applied to the driving switching element may be changed in the frame after the image transition so that the hysteresis characteristic of the driving switching element may be compensated. Accordingly, the luminance decrease in the frame after the image transition may be prevented. Thus, the display quality of the display panel may be enhanced.

In addition, the initialization operation of the driving switching element and the threshold voltage compensation operation of the driving switching element may not be repetitively performed so that the power consumption of the display apparatus may be reduced.

In addition, in a state in which the voltage applied to the driving switching element is changed in the frame after the image transition to compensate the hysteresis characteristic of the driving switching element, the variable frequency driving method may be easily applied to the display apparatus so that the power consumption of the display apparatus may be reduced by the variable frequency driving method.

### BRIEF DESCRIPTION OF THE DRAWINGS

The above and other features and advantages of the inventive concept will become more apparent by describing in detailed embodiments thereof with reference to the accompanying drawings, in which:

FIG. 1 is a block diagram illustrating an embodiment of a display apparatus according to the inventive concept;

FIG. 2 is a circuit diagram illustrating a pixel of a display panel of FIG. 1;

FIG. 3 is a timing diagram illustrating input signals applied to the pixel of FIG. 2;

FIG. 4A is a timing diagram illustrating an embodiment of a change of a bias voltage of FIG. 2 according to an image transition;

FIG. 4B is a timing diagram illustrating an embodiment of the change of the bias voltage of FIG. 2 according to the image transition;

FIG. 4C is a timing diagram illustrating an embodiment of the change of the bias voltage of FIG. 2 according to the image transition;

FIG. 5 is a graph illustrating a current-voltage curve of a first switching element of the pixel of FIG. 2;

FIG. 6 is a graph illustrating a luminance of a display image of the display panel of FIG. 1 according to the image transition;

FIG. 7A is a timing diagram illustrating an embodiment of a change of a data initialization voltage according to an image transition of a display apparatus according to the inventive concept;

FIG. 7B is a timing diagram illustrating an embodiment of a change of a data initialization voltage according to an image transition of a display apparatus according to the inventive concept;

FIG. 7C is a timing diagram illustrating an embodiment of a change of a data initialization voltage according to an image transition of a display apparatus according to the inventive concept;

FIG. 8A is a timing diagram illustrating an embodiment of a change of a bias voltage and a change of a data initialization voltage according to an image transition of a display apparatus according to the inventive concept;

FIG. 8B is a timing diagram illustrating an embodiment of a change of a bias voltage and a change of a data initialization voltage according to an image transition of a display apparatus according to the inventive concept;

FIG. 8C is a timing diagram illustrating an embodiment of a change of a bias voltage and a change of a data initialization voltage according to an image transition of a display apparatus according to the inventive concept;

FIG. 9 is a circuit diagram illustrating an embodiment of pixels of a display panel of a display apparatus according to the inventive concept;

FIGS. 10 and 11 are circuit diagrams illustrating pixels of a display panel of a display apparatus according to the inventive concept;

FIG. 12 is a timing diagram illustrating input signals applied to a pixel of a display apparatus according to the inventive concept;

FIG. 13 is a block diagram illustrating an embodiment of a display apparatus according to the inventive concept;

FIG. 14 is a block diagram illustrating an embodiment of an electronic apparatus according to the inventive concept; and

FIG. 15 is a diagram illustrating an embodiment in which the electronic apparatus of FIG. 14 is implemented as a smartphone.

### DETAILED DESCRIPTION OF THE INVENTIVE CONCEPT

Hereinafter, the inventive concept will be explained in detail with reference to the accompanying drawings.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

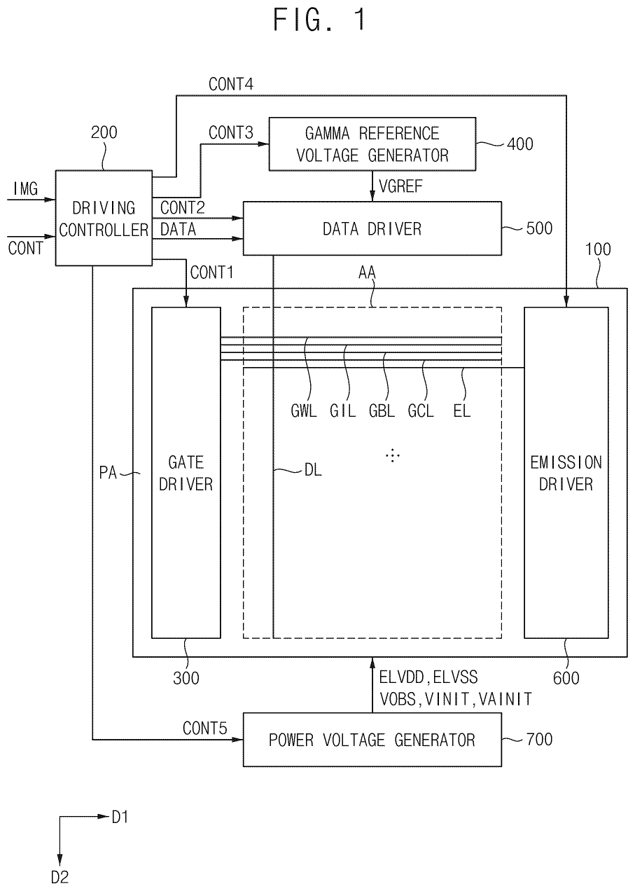

FIG. 1 is a block diagram illustrating an embodiment of a display apparatus according to the inventive concept.

Referring to FIG. 1, the display apparatus includes a display panel 100 and a display panel driver. The display panel driver includes a driving controller 200, a gate driver 300, a gamma reference voltage generator 400, a data driver 500 and an emission driver 600. The display apparatus may further include a power voltage generator 700.

The display panel 100 may include a pixel including a light-emitting element and a driving switching element. The display panel driver may determine an image transition of a display image of the display panel 100. When the image transition occurs, the display panel driver may change a voltage applied to the driving switching element in a frame after the image transition.

In an embodiment, the driving controller 200 and the data driver 500 may be unitarily formed, for example. In an embodiment, the driving controller 200, the gamma reference voltage generator 400 and the data driver 500 may be unitarily formed, for example. A driving module including at least the driving controller 200 and the data driver 500 which are unitarily formed may be referred to a timing controller embedded data driver (“TED”).

The display panel 100 has a display region AA on which an image is displayed and a peripheral region PA next (adjacent) to the display region AA.

The display panel 100 includes a plurality of gate lines GWL, GIL, GBL and GCL, a plurality of data lines DL, a plurality of emission lines EL and a plurality of pixels electrically connected to the gate lines GWL, GIL, GBL and GCL, the data lines DL and the emission lines EL. The gate lines GWL, GIL, GBL and GCL may extend in a first direction D1, the data lines DL may extend in a second direction D2 crossing the first direction D1 and the emission lines EL may extend in the first direction D1.

The driving controller 200 may receive input image data IMG and an input control signal CONT from an external apparatus. In an embodiment, the driving controller 200 may receive the input image data IMG and the input control signal CONT from a processor, for example. In an embodiment, the driving controller 200 may receive the input image data IMG and the input control signal CONT from a host, for example. In an embodiment, the input image data IMG may include red image data, green image data and blue image data, for example. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The driving controller 200 may generate the fourth control signal CONT4 for controlling an operation of the emission driver 600 based on the input control signal CONT, and may output the fourth control signal CONT4 to the emission driver 600.

The driving controller 200 may generate the fifth control signal CONT5 for controlling an operation of the power voltage generator 700 based on the input control signal CONT, and may output the fifth control signal CONT5 to the power voltage generator 700.

The gate driver 300 may generate gate signals driving the gate lines GWL, GIL, GBL and GCL in response to the first control signal CONT1 received from the driving controller 200. The gate driver 300 may output the gate signals to the gate lines GWL, GIL, GBL and GCL. In an embodiment, the gate driver 300 may be integrated on the peripheral region PA of the display panel 100, for example. In an embodiment, the gate driver 300 may be disposed (e.g., mounted) on the peripheral region PA of the display panel 100, for example.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and may receive the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL.

The emission driver 600 may generate emission signals to drive the emission lines EL in response to the fourth control signal CONT4 received from the driving controller 200. The emission driver 600 may output the emission signals to the emission lines EL. In an embodiment, the emission driver 600 may be integrated on the peripheral region PA of the display panel 100, for example. In an embodiment, the emission driver 600 may be disposed (e.g., mounted) on the peripheral region PA of the display panel 100, for example.

Although the gate driver 300 is disposed at a first side of the display panel 100 and the emission driver 600 is disposed at a second side of the display panel 100 opposite to the first side in FIG. 1 for convenience of explanation, the inventive concept may not be limited thereto. In an embodiment, both of the gate driver 300 and the emission driver 600 may be disposed at the first side of the display panel 100, for example. In an embodiment, both of the gate driver 300 and the emission driver 600 may be disposed opposite sides of the display panel 100, for example. In an embodiment, the gate driver 300 and the emission driver 600 may be unitarily formed, for example.

The power voltage generator 700 may generate power voltages of the display panel 100 in response to the fifth control signal CONT5 received from the driving controller 200. The power voltage generator 700 may output the power voltages of the display panel 100.

In an embodiment, the power voltages of the display panel 100 may include a first power voltage ELVDD, a second power voltage ELVSS, a bias voltage VOBS, a data initialization voltage VINIT and a light-emitting element initialization voltage VAINIT, for example.

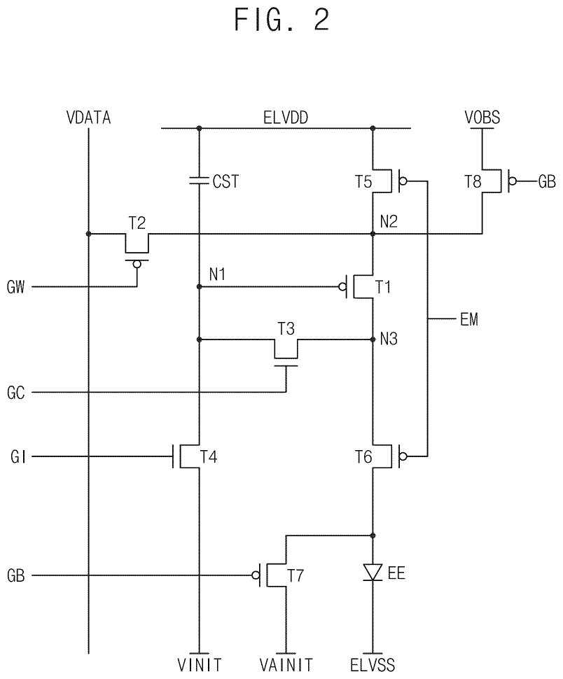

FIG. 2 is a circuit diagram illustrating the pixel of the display panel 100 of FIG. 1.

Referring to FIGS. 1 and 2, the display panel 100 includes the plurality of pixels. Each pixel includes a light-emitting element EE.

The pixel receives a writing gate signal GW, a compensation gate signal GC, a data initialization gate signal GI, a bias gate signal GB, the data voltage VDATA and the emission signal EM and the light-emitting element EE of the pixel emits light corresponding to the level of the data voltage VDATA to display the image.

In the illustrated embodiment, the pixel may include a switching element of a first type and a switching element of a second type different from the first type. In an embodiment, the switching element of the first type may be a polysilicon thin film transistor, for example. In an embodiment, the switching element of the first type may be a low temperature polysilicon (“LTPS”) thin film transistor, for example. In an embodiment, the switching element of the second type may be an oxide semiconductor thin film transistor, for example. In an embodiment, the switching element of the first type may be a P-type transistor and the switching element of the second type may be an N-type transistor, for example. Although the pixel includes the oxide semiconductor thin film transistor and the polysilicon thin film transistor in the illustrated embodiment, the inventive concept may not be limited thereto. The inventive concept may be applied to the pixel including the oxide semiconductor thin film transistors only. Although the pixel includes the N-type transistor and the P-type transistor in the illustrated embodiment, the inventive concept may not be limited thereto. The inventive concept may be applied to the pixel including the N-type transistors only.

In an embodiment, the pixel may include first, second, third, fourth, fifth, sixth, seventh and eighth switching elements T1, T2, T3, T4, T5, T6, T7 and T8, a storage capacitor CST and the light-emitting element EE. In an embodiment, the first switching element T1 may be a driving switching element, for example. In an embodiment, the second switching element T2 may be a writing switching element, for example. In an embodiment, the third switching element T3 may be a compensation switching element, for example. In an embodiment, the fourth switching element T4 may be a data initialization switching element, for example. In an embodiment, the fifth switching element T5 may be a first emission switching element, for example. In an embodiment, the sixth switching element T6 may be a second emission switching element, for example. In an embodiment, the seventh switching element T7 may be a light-emitting element initialization switching element, for example. In an embodiment, the eighth switching element T8 may be a bias switching element, for example.

The first switching element T1 includes a control electrode connected to a first node N1, a first electrode connected to a second node N2 and a second electrode connected to a third node N3.

The second switching element T2 includes a control electrode receiving the writing gate signal GW, a first electrode receiving the data voltage VDATA and a second electrode connected to the second node N2.

The third switching element T3 includes a control electrode receiving the compensation gate signal GC, a first electrode connected to the first node N1 and a second electrode connected to the third node N3.

The fourth switching element T4 includes a control electrode receiving the data initialization gate signal GI, a first electrode receiving a data initialization voltage VINIT and a second electrode connected to the first node N1.

The fifth switching element T5 includes a control electrode receiving the emission signal EM, a first electrode receiving a first power voltage ELVDD and a second electrode connected to the second node N2.

The sixth switching element T6 includes a control electrode receiving the emission signal EM, a first electrode connected to the third node N3 and a second electrode connected to an anode electrode of the light-emitting element EE.

The seventh switching element T7 includes a control electrode receiving the bias gate signal GB, a first electrode receiving a light-emitting element initialization voltage VAINIT and a second electrode connected to the anode electrode of the light-emitting element EE. Although the light-emitting element initialization voltage VAINIT is applied to the first electrode of the seventh switching element T7 in the illustrated embodiment, the inventive concept may not be limited thereto. In an embodiment, the data initialization voltage VINIT may be applied to the first electrode of the seventh switching element T7. The bias gate signal GB may be also referred to as a light-emitting element initialization gate signal.

The eighth switching element T8 may include a control electrode receiving the bias gate signal GB, a first electrode receiving the bias voltage VOBS and a second electrode connected to the second node N2.

The storage capacitor CST includes a first electrode receiving the first power voltage ELVDD and a second electrode connected to the first node N1.

The light-emitting element EE includes the anode electrode and a cathode electrode receiving a second power voltage ELVSS.

The first power voltage ELVDD may be greater than the second power voltage ELVSS.

A driving current of the pixel may sequentially flow through the fifth switching element T5, the first switching element T1 and the sixth switching element T6 to drive the light-emitting element EE. An intensity of the driving current may be determined according to a level of the data voltage VDATA. A luminance of the light-emitting element EE may be determined according to the intensity of the driving current.

In the illustrated embodiment, when the image displayed on the display panel 100 is a static image or the display panel 100 is operated in always on mode, a driving frequency of the display panel 100 may be decreased to reduce a power consumption. When all of the switching elements of the pixel of the display panel 100 are polysilicon thin film transistors, a flicker may be generated due to a leakage current of the switching element in a low frequency driving mode driven with a relatively low frequency. Thus, some of the switching elements of the pixel may be implemented as oxide semiconductor thin film transistors. In the illustrated embodiment, the third switching element T3 and the fourth switching element T4 may be oxide semiconductor thin film transistors. The first switching element T1, the second switching element T2, the fifth switching element T5, the sixth switching element T6, the seventh switching element T7 and the eighth switching element T8 may be polysilicon thin film transistors. In the illustrated embodiment, the third switching element T3 and the fourth switching element T4 may be N-type transistors. The first switching element T1, the second switching element T2, the fifth switching element T5, the sixth switching element T6, the seventh switching element T7 and the eighth switching element T8 may be P-type transistors.

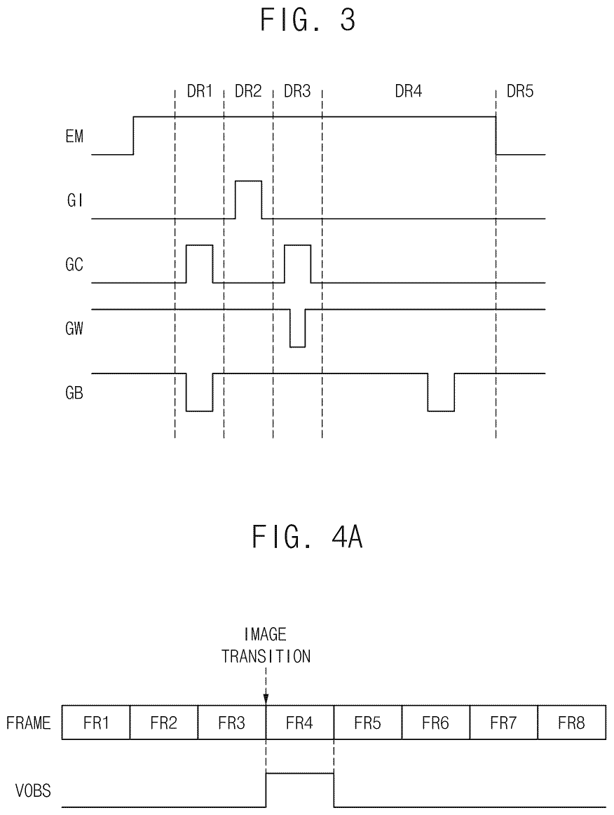

FIG. 3 is a timing diagram illustrating input signals applied to the pixel of FIG. 2.

Referring to FIGS. 1 to 3, a driving timing of the pixel may include a first period DR1, a second period DR2, a third period DR3, a fourth period DR4 and a fifth period DR5.

When the emission signal EM, the data initialization gate signal GI, the compensation gate signal GC, the writing gate signal GW and the bias gate signal GB are applied to P-type transistors, active levels of the emission signal EM, the data initialization gate signal GI, the compensation gate signal GC, the writing gate signal GW and the bias gate signal GB may be relatively low levels and inactive levels of the emission signal EM, the data initialization gate signal GI, the compensation gate signal GC, the writing gate signal GW and the bias gate signal GB may be relatively high levels.

When the emission signal EM, the data initialization gate signal GI, the compensation gate signal GC, the writing gate signal GW and the bias gate signal GB are applied to N-type transistors, active levels of the emission signal EM, the data initialization gate signal GI, the compensation gate signal GC, the writing gate signal GW and the bias gate signal GB may be relatively high levels and inactive levels of the emission signal EM, the data initialization gate signal GI, the compensation gate signal GC, the writing gate signal GW and the bias gate signal GB may be relatively low levels.

In the illustrated embodiment, the emission signal EM, the writing gate signal GW and the bias gate signal GB are applied to P-type transistors so that active levels of the emission signal EM, the writing gate signal GW and the bias gate signal GB may be relatively low levels and inactive levels of the emission signal EM, the writing gate signal GW and the bias gate signal GB may be relatively high levels.

In the illustrated embodiment, the data initialization gate signal GI and the compensation gate signal GC are applied to N-type transistors so that active levels of the data initialization gate signal GI and the compensation gate signal GC may be relatively high levels and inactive levels of the data initialization gate signal GI and the compensation gate signal GC may be relatively low levels.

In the first period DR1, the emission signal EM may have an inactive level, the data initialization gate signal GI may have an inactive level, the compensation gate signal GC may have an active pulse, the writing gate signal GW may have an inactive level and the bias gate signal GB may have an active pulse.

In the first period DR1, the seventh switching element T7 may be turned on in response to the bias gate signal GB so that the light-emitting element initialization voltage VAINIT may be applied to the anode electrode of the light-emitting element EE.

In the first period DR1, the eighth switching element T8 may be turned on in response to the bias gate signal GB so that the bias voltage VOBS may be applied to the second node N2.

In the first period DR1, the third switching element T3 may be turned on in response to the compensation gate signal GC so that the first node N1 and the third node N3 may be connected to each other.

In the second period DR2 subsequent to the first period DR1, the emission signal EM may have the inactive level, the data initialization gate signal GI may have an active pulse, the compensation gate signal GC may have an inactive level, the writing gate signal GW may have the inactive level and the bias gate signal GB may have an inactive level.

In the second period DR2, the fourth switching element T4 may be turned on in response to the data initialization gate signal GI so that the data initialization voltage VINIT may be applied to the first node N1.

In the third period DR3 subsequent to the second period DR2, the emission signal EM may have the inactive level, the data initialization gate signal GI may have the inactive level, the compensation gate signal GC may have an active pulse, the writing gate signal GW may have an active pulse and the bias gate signal GB may have the inactive level.

In the third period DR3, the second switching element T2 may be turned on in response to the writing gate signal GW and the third switching element T3 may be turned on in response to the compensation gate signal GC so that the data voltage VDATA in which a threshold voltage of the first switching element T1 is compensated may be written to the first node N1.

In the fourth period DR4 subsequent to the third period DR3, the emission signal EM may have the inactive level, the data initialization gate signal GI may have the inactive level, the compensation gate signal GC may have the inactive level, the writing gate signal GW may have the inactive level and the bias gate signal GB may have an active pulse.

In the fourth period DR4, the seventh switching element T7 may be turned on in response to the bias gate signal GB so that the light-emitting element initialization voltage VAINIT may be applied to the anode electrode of the light-emitting element EE.

In the fifth period DR5 subsequent to the fourth period DR4, the emission signal EM may have an active level, the data initialization gate signal GI may have the inactive level, the compensation gate signal GC may have the inactive level, the writing gate signal GW may have the inactive level and the bias gate signal GB may have the inactive level.

In the fifth period DR5, the fifth switching element T5 and the sixth switching element T6 may be turned on in response to the emission signal EM and the first switching element T1 may be turned on by the data voltage VDATA so that the light-emitting element EE may emit a light.

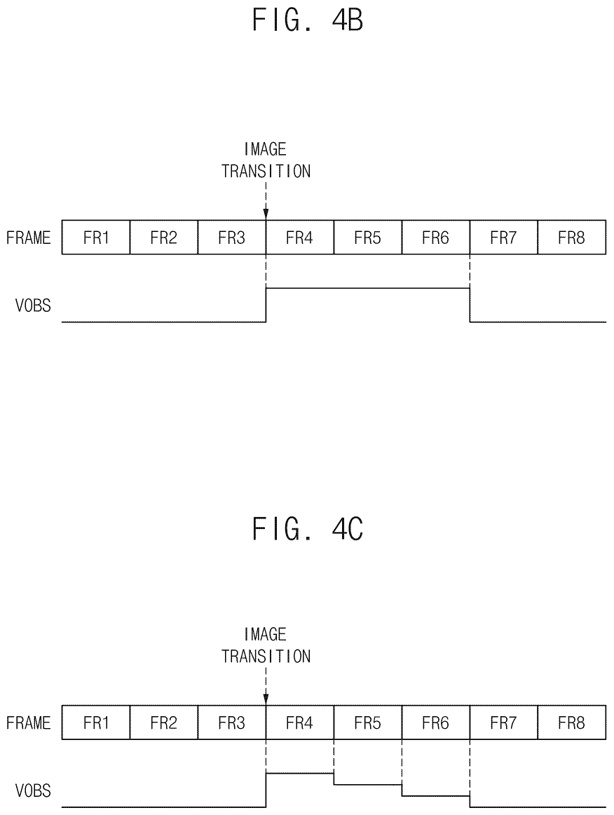

FIG. 4A is a timing diagram illustrating an embodiment of a change of the bias voltage VOBS of FIG. 2 according to an image transition.

Referring to FIGS. 1 to 4A, the display panel driver determines an image transition of a display image of the display panel 100. When the image transition occurs, the display panel driver may change a voltage applied to the driving switching element T1 in a frame after the image transition.

In the illustrated embodiment, when the display panel driver receives an updated image, the display panel driver may determine the image transition. In an embodiment, when a current input image is the same as a previous input image, the processor may not output the input image data IMG to the display panel driver, for example. In contrast, when the current input image is different from the previous input image, the processor may output the input image data IMG to the display panel driver.

Accordingly, in the illustrated embodiment, when the display panel driver receives an image from the processor, it may mean that the image transition occurs.

In the illustrated embodiment, the display panel driver may increase the bias voltage VOBS applied to the first electrode of the driving switching element T1 in a frame after the image transition.

In the illustrated embodiment, the voltage (e.g., the bias voltage VOBS) applied to the driving switching element T1 and changed in the frame after the image transition may be commonly applied to all of the pixels of the display panel 100.

First to eighth frames FR1 to FR8 are illustrated in FIG. 4A and FIG. 4A illustrates a case in which an image transition occurs in the third frame FR3 or between the third frame FR3 and the fourth frame FR4. Accordingly, a frame right after the image transition may be the fourth frame FR4 in FIG. 4A.

In FIG. 4A, the display panel driver may increase the bias voltage VOBS applied to the first electrode of the driving switching element T1 in one frame (e.g., the fourth frame FR4) after the image transition.

As explained above, when a positive offset is applied to the bias voltage VOBS in the frame after the image transition, a source voltage of the driving switching element T1 may be increased. When the source voltage of the driving switching element T1 is increased, a hysteresis characteristic of the driving switching element T1 may be enhanced and a shift of the threshold voltage due to the hysteresis characteristic of the driving switching element T1 may be reduced so that a luminance of the image may be increased in the frame after the image transition.

FIG. 4B is a timing diagram illustrating an embodiment of a change of the bias voltage VOBS of FIG. 2 according to the image transition.

First to eighth frames FR1 to FR8 are illustrated in FIG. 4B and FIG. 4B illustrates a case in which an image transition occurs in the third frame FR3 or between the third frame FR3 and the fourth frame FR4. Accordingly, a frame right after the image transition may be the fourth frame FR4 in FIG. 4B.

In FIG. 4B, the display panel driver may increase the bias voltage VOBS applied to the first electrode of the driving switching element T1 in plural consecutive frames (e.g., the fourth frame FR4, the fifth frame FR5 and the sixth frame FR6) after the image transition.

Although the bias voltage VOBS is increased in one frame (e.g., the fourth frame FR4) after the image transition in FIG. 4A, a desired luminance may not be displayed due to the hysteresis characteristic of the driving switching element T1 in plural frames. Thus, as shown in FIG. 4B, the bias voltage VOBS may be increased in the plural consecutive frames (e.g., the fourth frame FR4, the fifth frame FR5 and the sixth frame FR6) after the image transition.

FIG. 4C is a timing diagram illustrating an embodiment of a change of the bias voltage VOBS of FIG. 2 according to the image transition.

First to eighth frames FR1 to FR8 are illustrated in FIG. 4C and FIG. 4C illustrates a case in which an image transition occurs in the third frame FR3 or between the third frame FR3 and the fourth frame FR4. Accordingly, a frame right after the image transition may be the fourth frame FR4 in FIG. 4C.

In FIG. 4C, the display panel driver may increase the bias voltage VOBS applied to the first electrode of the driving switching element T1 in plural consecutive frames (e.g., the fourth frame FR4, the fifth frame FR5 and the sixth frame FR6) after the image transition.

In FIG. 4C, an increase of the bias voltage VOBS may gradually decrease in the plural consecutive frames (e.g., the fourth frame FR4, the fifth frame FR5 and the sixth frame FR6) after the image transition.

In an embodiment, a first increase of the bias voltage VOBS in a first frame (e.g., the fourth frame FR4) after the image transition may be greater than a second increase of the bias voltage VOBS in a second frame (e.g., the fifth frame FR5) after the image transition, for example.

In an embodiment, the second increase of the bias voltage VOBS in the second frame (e.g., the fifth frame FR5) after the image transition may be greater than a third increase of the bias voltage VOBS in a third frame (e.g., the sixth frame FR6) after the image transition, for example.

Although the bias voltage VOBS is constantly increased in the plural consecutive frames (e.g., the fourth frame FR4, the fifth frame FR5 and the sixth frame FR6) after the image transition in FIG. 4B, a difference between a desired luminance and an actual luminance may be greatest in the first frame after the image transition and the difference between the desired luminance and the actual luminance may decrease as time passes. Thus, as shown in FIG. 4C, an offset of the bias voltage VOBS may gradually decrease in the plural consecutive frames (e.g., the fourth frame FR4, the fifth frame FR5 and the sixth frame FR6) after the image transition.

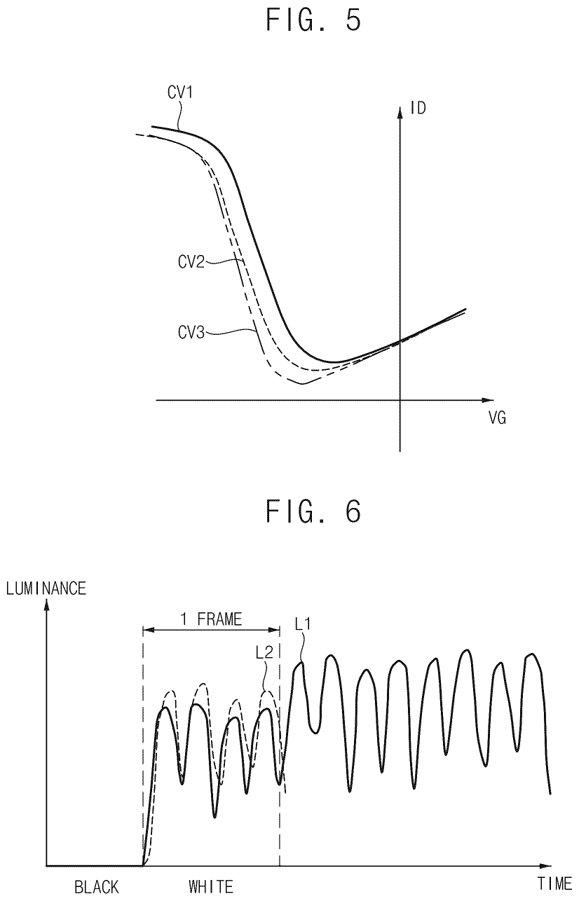

FIG. 5 is a graph illustrating a current-voltage curve of the first switching element T1 of the pixel of FIG. 2.

In FIG. 5, a first curve CV1 may represent a drain current ID for a gate voltage VG of the first switching element T1 when a display image changes from a low grayscale image to a high grayscale image and a third curve CV3 may represent the drain current ID for the gate voltage VG of the first switching element T1 when the display image changes from a high grayscale image to a low grayscale image. Here, the low grayscale image may be represented by a relatively low grayscale value, and the high scale image may be represented by a relatively high grayscale value. In an embodiment, the relatively low grayscale value may refer to a grayscale value less than an average gray scale value, and the relatively high grayscale value may refer to a grayscale value greater than the average gray scale value, for example, but the disclosure is not limited thereto.

In FIG. 5, a second curve CV2 may represent the drain current ID for the gate voltage VG of the first switching element T1 when the display image changes from a low grayscale image to a high grayscale image and the bias voltage VOBS is increased in the frame (e.g., the fourth frame FR4 in FIG. 4A) after the image transition.

When the bias voltage VOBS is not increased in the frame (e.g., the fourth frame FR4 in FIG. 4A) after the image transition, the hysteresis characteristic of the first switching element T1 may be defined as the first curve CV1 and the third curve CV3.

When the bias voltage VOBS is increased in the frame (e.g., the fourth frame FR4 in FIG. 4A) after the image transition, the hysteresis characteristic of the first switching element T1 may be defined as the second curve CV2 and the third curve CV3.

As explained above, when the bias voltage VOBS is increased in the frame (e.g., the fourth frame FR4 in FIG. 4A) after the image transition, a difference between a threshold voltage of the driving switching element T1 when the display image is changed from the low grayscale image to the high grayscale image (CV2) and a threshold voltage of the driving switching element T1 when the display image is changed from the high grayscale image to the low grayscale image (CV3) may be reduced.

FIG. 6 is a graph illustrating a luminance of a display image of the display panel 100 of FIG. 1 according to the image transition.

Referring to FIGS. 1 to 6, a first luminance L1 represents a luminance when the bias voltage VOBS is not increased in the frame (e.g., the fourth frame FR4) after the image transition and a second luminance L2 represents a luminance when the bias voltage VOBS is increased in the frame (e.g., the fourth frame FR4) after the image transition.

When the bias voltage VOBS is increased in the frame (e.g., the fourth frame FR4) after the image transition, the hysteresis characteristic of the driving switching element T1 may be enhanced, and accordingly, a desired luminance may be displayed in an early time period after the image transition.

In the illustrated embodiment, the voltage (e.g., the bias voltage VOBS) applied to the driving switching element T1 may be changed in the frame (e.g., the fourth frame FR4 or the fourth to sixth frames FR4 to FR6) after the image transition so that the hysteresis characteristic of the driving switching element T1 may be compensated. Accordingly, the luminance decrease in the frame after the image transition may be prevented. Thus, the display quality of the display panel 100 may be enhanced.

In addition, the initialization operation of the driving switching element T1 and the threshold voltage compensation operation of the driving switching element T1 may not be repetitively performed so that the power consumption of the display apparatus may be reduced.

In addition, when the voltage (e.g., the bias voltage VOBS) applied to the driving switching element T1 is changed in the frame after the image transition to compensate the hysteresis characteristic of the driving switching element T1, a variable frequency driving method may be easily applied to the display apparatus so that the power consumption of the display apparatus may be reduced by the variable frequency driving method.

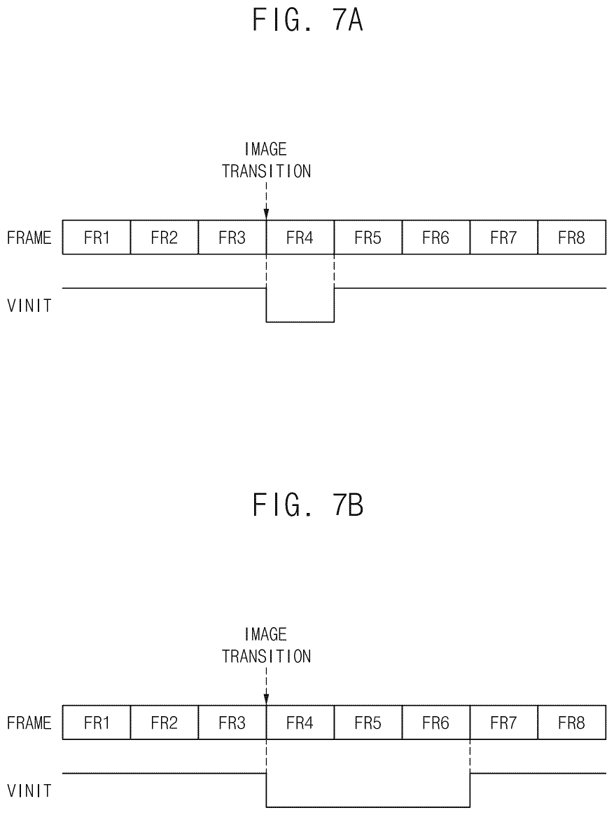

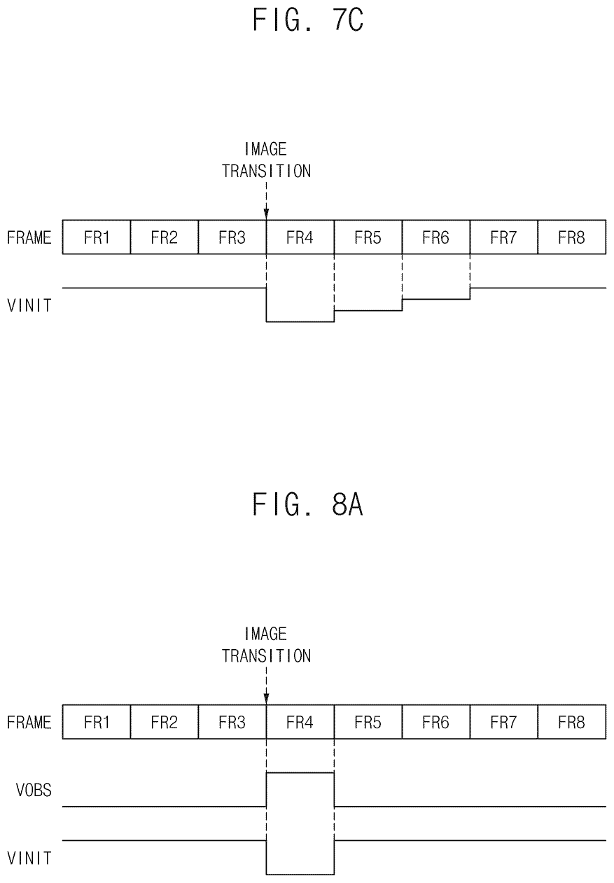

FIG. 7A is a timing diagram illustrating an embodiment of a change of a data initialization voltage VINIT according to an image transition of a display apparatus according to the inventive concept. FIG. 7B is a timing diagram illustrating an embodiment of a change of the data initialization voltage VINIT according to an image transition of the display apparatus according to the inventive concept. FIG. 7C is a timing diagram illustrating an embodiment of a change of the data initialization voltage VINIT according to an image transition of the display apparatus according to the inventive concept.

The display apparatus in the illustrated embodiment is substantially the same as the display apparatus of the previous embodiment explained referring to FIGS. 1 to 6 except that the data initialization voltage VINIT applied to the control electrode of the driving switching element T1 is changed instead of the bias voltage VOBS. Thus, the same reference numerals will be used to refer to the same or like parts as those described in the previous embodiment of FIGS. 1 to 6 and any repetitive explanation concerning the above elements will be omitted.

Referring to FIGS. 1 to 3, 5, 6 and 7A to 7C, the display panel driver determines an image transition of a display image of the display panel 100. When the image transition occurs, the display panel driver may change a voltage applied to the driving switching element T1 in a frame after the image transition.

In the illustrated embodiment, the display panel driver may decrease the data initialization voltage VINIT applied to the control electrode of the driving switching element T1 in a frame after the image transition.

In the illustrated embodiment, the voltage (e.g., the data initialization voltage VINIT) applied to the driving switching element T1 and changed in the frame after the image transition may be commonly applied to all of the pixels of the display panel 100.

First to eighth frames FR1 to FR8 are illustrated in FIGS. 7A to 7C and FIGS. 7A to 7C illustrate a case in which an image transition occurs in the third frame FR3 or between the third frame FR3 and the fourth frame FR4. Accordingly, a frame right after the image transition may be the fourth frame FR4 in FIGS. 7A to 7C.

In FIG. 7A, the display panel driver may decrease the data initialization voltage VINIT applied to the control electrode of the driving switching element T1 in one frame (e.g., the fourth frame FR4) after the image transition.

As explained above, when a negative offset is applied to the data initialization voltage VINIT in the frame after the image transition, a gate voltage of the driving switching element T1 may be decreased. When the gate voltage of the driving switching element T1 is decreased, a hysteresis characteristic of the driving switching element T1 may be enhanced and a shift of the threshold voltage due to the hysteresis characteristic of the driving switching element T1 may be reduced so that a luminance of the image may be increased in the frame after the image transition.

In FIG. 7B, the display panel driver may decrease the data initialization voltage VINIT applied to the control electrode of the driving switching element T1 in plural consecutive frames (e.g., the fourth frame FR4, the fifth frame FR5 and the sixth frame FR6) after the image transition.

In FIG. 7C, the display panel driver may decrease the data initialization voltage VINIT applied to the control electrode of the driving switching element T1 in plural consecutive frames (e.g., the fourth frame FR4, the fifth frame FR5 and the sixth frame FR6) after the image transition.

In FIG. 7C, a decrease of the data initialization voltage VINIT may gradually decrease in the plural consecutive frames (e.g., the fourth frame FR4, the fifth frame FR5 and the sixth frame FR6) after the image transition.

In an embodiment, a first decrease of the data initialization voltage VINIT in a first frame (e.g., the fourth frame FR4) after the image transition may be greater than a second decrease of the data initialization voltage VINIT in a second frame (e.g., the fifth frame FR5) after the image transition, for example.

In an embodiment, the second decrease of the data initialization voltage VINIT in the second frame (e.g., the fifth frame FR5) after the image transition may be greater than a third decrease of the data initialization voltage VINIT in a third frame (e.g., the sixth frame FR6) after the image transition, for example.

As explained above, when the data initialization voltage VINIT is decreased in the frame (e.g., the fourth frame FR4) after the image transition, a difference between a threshold voltage of the driving switching element T1 when the display image is changed from the low grayscale image to the high grayscale image (CV2 in FIG. 5) and a threshold voltage of the driving switching element T1 when the display image is changed from the high grayscale image to the low grayscale image (CV3 in FIG. 5) may be reduced.

When the data initialization voltage VINIT is decreased in the frame (e.g., the fourth frame FR4) after the image transition, the hysteresis characteristic of the driving switching element T1 may be enhanced, and accordingly, a desired luminance may be displayed in an early time period after the image transition.

In the illustrated embodiment, the voltage (e.g., the data initialization voltage VINIT) applied to the driving switching element T1 may be changed in the frame (e.g., the fourth frame FR4 or the fourth to sixth frames FR4 to FR6) after the image transition so that the hysteresis characteristic of the driving switching element T1 may be compensated. Accordingly, the luminance decrease in the frame after the image transition may be prevented. Thus, the display quality of the display panel 100 may be enhanced.

In addition, the initialization operation of the driving switching element T1 and the threshold voltage compensation operation of the driving switching element T1 may not be repetitively performed so that the power consumption of the display apparatus may be reduced. In addition, when the voltage (e.g., the data initialization voltage VINIT) applied to the driving switching element T1 is changed in the frame after the image transition to compensate the hysteresis characteristic of the driving switching element T1, a variable frequency driving method may be easily applied to the display apparatus so that the power consumption of the display apparatus may be reduced by the variable frequency driving method.

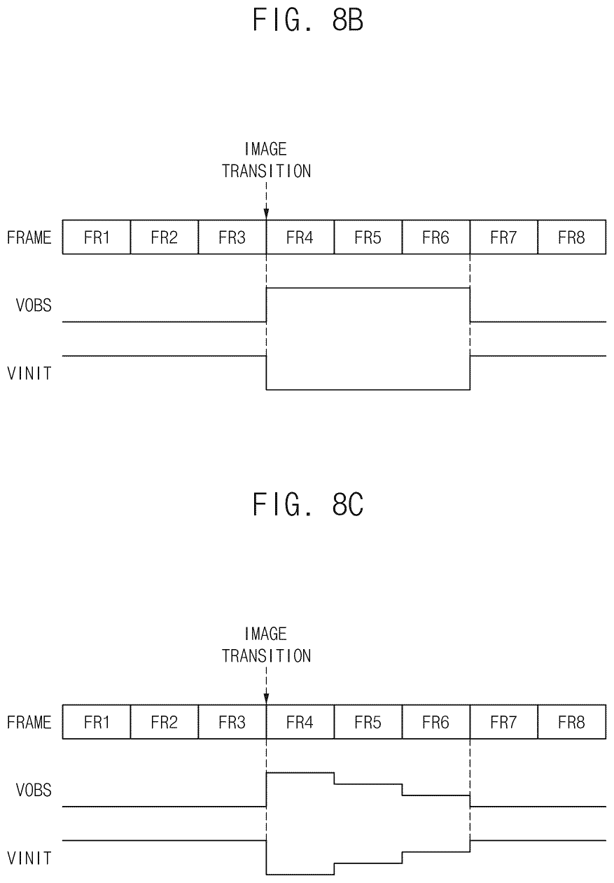

FIG. 8A is a timing diagram illustrating an embodiment of a change of a bias voltage VOBS and a change of a data initialization voltage VINIT according to an image transition of a display apparatus according to the inventive concept. FIG. 8B is a timing diagram illustrating an embodiment of a change of the bias voltage VOBS and a change of the data initialization voltage VINIT according to an image transition of the display apparatus according to the inventive concept. FIG. 8C is a timing diagram illustrating an embodiment of a change of the bias voltage VOBS and a change of the data initialization voltage VINIT according to an image transition of the display apparatus according to the inventive concept.

The display apparatus in the illustrated embodiment is substantially the same as the display apparatus of the previous embodiment explained referring to FIGS. 1 to 6 except that the data initialization voltage VINIT applied to the control electrode of the driving switching element T1 is changed with the bias voltage VOBS. Thus, the same reference numerals will be used to refer to the same or like parts as those described in the previous embodiment of FIGS. 1 to 6 and any repetitive explanation concerning the above elements will be omitted.

Referring to FIGS. 1 to 3, 5, 6 and 8A to 8C, the display panel driver determines an image transition of a display image of the display panel 100. When the image transition occurs, the display panel driver may change a voltage applied to the driving switching element T1 in a frame after the image transition.

In the illustrated embodiment, the display panel driver may increase the bias voltage VOBS applied to the first electrode of the driving switching element T1 and decrease the data initialization voltage VINIT applied to the control electrode of the driving switching element T1 in a frame after the image transition.

First to eighth frames FR1 to FR8 are illustrated in FIGS. 8A to 8C and FIGS. 8A to 8C illustrate a case in which an image transition occurs in the third frame FR3 or between the third frame FR3 and the fourth frame FR4. Accordingly, a frame right after the image transition may be the fourth frame FR4 in FIGS. 8A to 8C.

In FIG. 8A, the display panel driver may increase the bias voltage VOBS applied to the first electrode of the driving switching element T1 and decrease the data initialization voltage VINIT applied to the control electrode of the driving switching element T1 in one frame (e.g., the fourth frame FR4) after the image transition.

As explained above, when a positive offset is applied to the bias voltage VOBS and a negative offset is applied to the data initialization voltage VINIT in the frame after the image transition, a source voltage of the driving switching element T1 may be increased and a gate voltage of the driving switching element T1 may be decreased. When the source voltage of the driving switching element T1 is increased and the gate voltage of the driving switching element T1 is decreased, a hysteresis characteristic of the driving switching element T1 may be enhanced and a shift of the threshold voltage due to the hysteresis characteristic of the driving switching element T1 may be reduced so that a luminance of the image may be increased in the frame after the image transition.

In FIG. 8B, the display panel driver may increase the bias voltage VOBS applied to the first electrode of the driving switching element T1 and decrease the data initialization voltage VINIT applied to the control electrode of the driving switching element T1 in plural consecutive frames (e.g., the fourth frame FR4, the fifth frame FR5 and the sixth frame FR6) after the image transition.

In FIG. 8C, the display panel driver may increase the bias voltage VOBS applied to the first electrode of the driving switching element T1 and decrease the data initialization voltage VINIT applied to the control electrode of the driving switching element T1 in plural consecutive frames (e.g., the fourth frame FR4, the fifth frame FR5 and the sixth frame FR6) after the image transition.

In FIG. 8C, an increase of the bias voltage VOBS and a decrease of the data initialization voltage VINIT may gradually decrease in the plural consecutive frames (e.g., the fourth frame FR4, the fifth frame FR5 and the sixth frame FR6) after the image transition.

In an embodiment, a first increase of the bias voltage VOBS in a first frame (e.g., the fourth frame FR4) after the image transition may be greater than a second increase of the bias voltage VOBS in a second frame (e.g., the fifth frame FR5) after the image transition, for example.

In an embodiment, the second increase of the bias voltage VOBS in the second frame (e.g., the fifth frame FR5) after the image transition may be greater than a third increase of the bias voltage VOBS in a third frame (e.g., the sixth frame FR6) after the image transition, for example.

In an embodiment, a first decrease of the data initialization voltage VINIT in the first frame (e.g., the fourth frame FR4) after the image transition may be greater than a second decrease of the data initialization voltage VINIT in the second frame (e.g., the fifth frame FR5) after the image transition, for example.

In an embodiment, the second decrease of the data initialization voltage VINIT in the second frame (e.g., the fifth frame FR5) after the image transition may be greater than a third decrease of the data initialization voltage VINIT in the third frame (e.g., the sixth frame FR6) after the image transition, for example.

As explained above, when the bias voltage VOBS is increased and the data initialization voltage VINIT is decreased in the frame (e.g., the fourth frame FR4) after the image transition, a difference between a threshold voltage of the driving switching element T1 when the display image is changed from the low grayscale image to the high grayscale image (CV2 in FIG. 5) and a threshold voltage of the driving switching element T1 when the display image is changed from the high grayscale image to the low grayscale image (CV3 in FIG. 5) may be reduced.

When the bias voltage VOBS is increased and the data initialization voltage VINIT is decreased in the frame (e.g., the fourth frame FR4) after the image transition, the hysteresis characteristic of the driving switching element T1 may be enhanced, and accordingly, a desired luminance may be displayed in an early time period after the image transition.

In the illustrated embodiment, the voltage (e.g., the bias voltage VOBS and the data initialization voltage VINIT) applied to the driving switching element T1 may be changed in the frame (e.g., the fourth frame FR4 or the fourth to sixth frames FR4 to FR6) after the image transition so that the hysteresis characteristic of the driving switching element T1 may be compensated. Accordingly, the luminance decrease in the frame after the image transition may be prevented. Thus, the display quality of the display panel 100 may be enhanced.

In addition, the initialization operation of the driving switching element T1 and the threshold voltage compensation operation of the driving switching element T1 may not be repetitively performed so that the power consumption of the display apparatus may be reduced.

In addition, when the voltage (e.g., the bias voltage VOBS and the data initialization voltage VINIT) applied to the driving switching element T1 is changed in the frame after the image transition to compensate the hysteresis characteristic of the driving switching element T1, a variable frequency driving method may be easily applied to the display apparatus so that the power consumption of the display apparatus may be reduced by the variable frequency driving method.

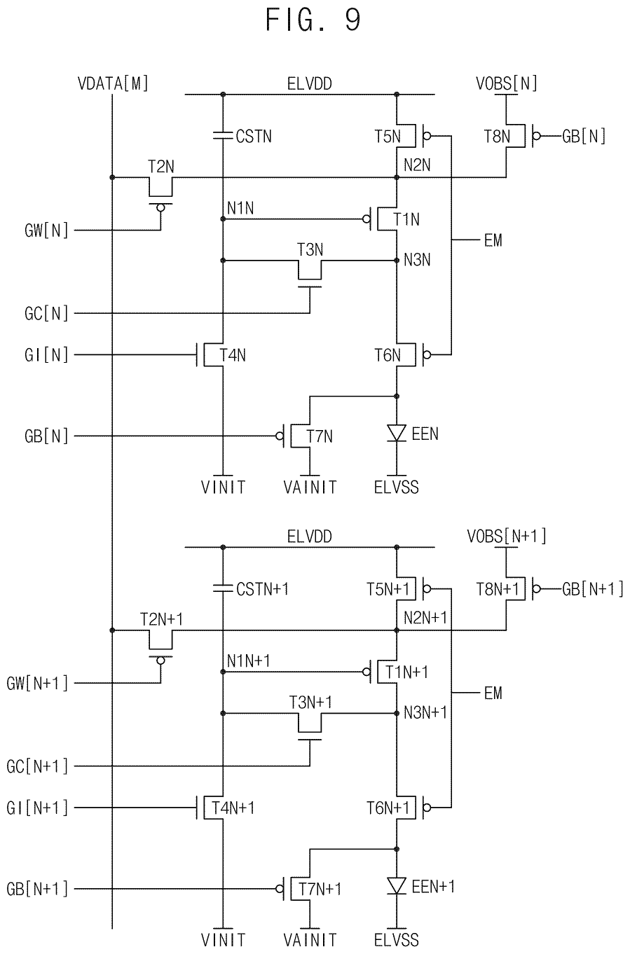

FIG. 9 is a circuit diagram illustrating an embodiment of pixels of a display panel 100 of a display apparatus according to the inventive concept.

The display apparatus in the illustrated embodiment is substantially the same as the display apparatus of the previous embodiment explained referring to FIGS. 1 to 6 except that the voltage changed in the frame after the image transition is independently controlled in a unit of a pixel row of the display panel. Thus, the same reference numerals will be used to refer to the same or like parts as those described in the previous embodiment of FIGS. 1 to 6 and any repetitive explanation concerning the above elements will be omitted.

Referring to FIGS. 1, 3 to 6 and 9, in the illustrated embodiment, the voltage (e.g., the bias voltage VOBS) applied to the driving switching element T1 and changed in the frame after the image transition may be independently applied in a unit of a pixel row of the display panel 100. Although the voltage changed in the frame after the image transition is the bias voltage VOBS and the bias voltage VOBS is independently applied in a unit of the pixel row in FIG. 9, the inventive concept may not be limited thereto. The voltage changed in the frame after the image transition may be the data initialization voltage VINIT as shown in the embodiments of FIGS. 7A to 7C and the data initialization voltage VINIT may be independently applied in a unit of the pixel row. The voltages changed in the frame after the image transition may be the bias voltage VOBS and the data initialization voltage VINIT as shown in the embodiments of FIGS. 8A to 8C and the bias voltage VOBS and the data initialization voltage VINIT may be independently applied in a unit of the pixel row.

In FIG. 9, a pixel disposed in an N-th pixel row may include first, second, third, fourth, fifth, sixth, seventh and eighth switching elements T1N, T2N, T3N, T4N, T5N, T6N, T7N and T8N, a storage capacitor CSTN and the light-emitting element EEN. Herein, N is a positive integer. In an embodiment, the first switching element T1N includes a control electrode connected to a first node N1N, a first electrode connected to a second node N2N and a second electrode connected to a third node N3N.

The pixel disposed in the N-th pixel row receives a writing gate signal GW[N], a compensation gate signal GC[N], a data initialization gate signal GI[N], a bias gate signal GB[N], the data voltage VDATA[M] and the emission signal EM[N] and the light-emitting element EEN of the pixel emits light corresponding to the level of the data voltage VDATA[M] to display the image.

In FIG. 9, a pixel disposed in an N+1-th pixel row may include first, second, third, fourth, fifth, sixth, seventh and eighth switching elements T1N+1, T2N+1, T3N+1, T4N+1, T5N+1, T6N+1, T7N+1 and T8N+1, a storage capacitor CSTN+1 and the light-emitting element EEN+1. In an embodiment, the first switching element T1N+1 includes a control electrode connected to a first node N1N+1, a first electrode connected to a second node N2N+1 and a second electrode connected to a third node N3N+1.

The pixel disposed in the N+1-th pixel row receives a writing gate signal GW[N+1], a compensation gate signal GC[N+1], a data initialization gate signal GI[N+1], a bias gate signal GB[N+1], the data voltage VDATA[M] and the emission signal EM[N+1] and the light-emitting element EEN+1 of the pixel emits light corresponding to the level of the data voltage VDATA[M] to display the image.

In the illustrated embodiment, an N-th bias voltage VOBS[N] may be applied to the eighth switching element T8N of the pixel disposed in the N-th pixel row and an N+1-th bias voltage VOBS[N+1] may be applied to the eighth switching element T8N+1 of the pixel disposed in the N+1-th pixel row.

In the illustrated embodiment, the bias voltage VOBS is changed only for the pixel row in which the image transition occurs so that a unit of hysteresis characteristic compensation of the driving switching element T1 may be subdivided into a unit of the pixel row. In addition, the bias voltage VOBS of the pixel row in which the image transition does not occur may not be changed so that an unexpected display defect due to the change of the bias voltage VOBS may be prevented.

In the illustrated embodiment, the voltage (e.g., the bias voltage VOBS and the data initialization voltage VINIT) applied to the driving switching element T1 may be changed in the frame (e.g., the fourth frame FR4 or the fourth to sixth frames FR4 to FR6) after the image transition so that the hysteresis characteristic of the driving switching element T1 may be compensated. Accordingly, the luminance decrease in the frame after the image transition may be prevented. Thus, the display quality of the display panel 100 may be enhanced.

In addition, the initialization operation of the driving switching element T1 and the threshold voltage compensation operation of the driving switching element T1 may not be repetitively performed so that the power consumption of the display apparatus may be reduced.

In addition, when the voltage (e.g., the bias voltage VOBS and the data initialization voltage VINIT) applied to the driving switching element T1 is changed in the frame after the image transition to compensate the hysteresis characteristic of the driving switching element T1, a variable frequency driving method may be easily applied to the display apparatus so that the power consumption of the display apparatus may be reduced by the variable frequency driving method.

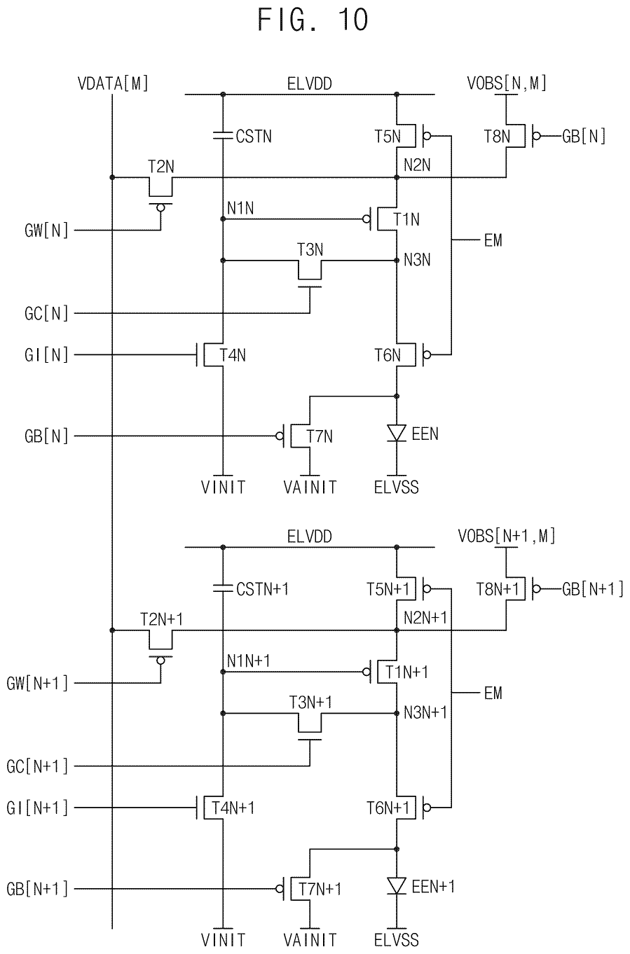

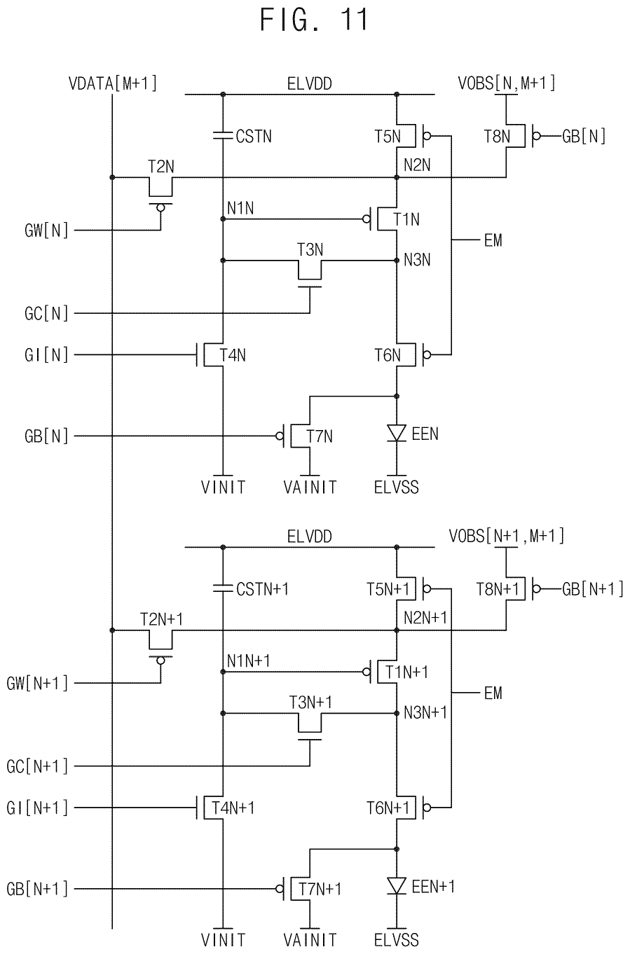

FIGS. 10 and 11 are circuit diagrams illustrating an embodiment of pixels of a display panel of a display apparatus according to the inventive concept.

The display apparatus in the illustrated embodiment is substantially the same as the display apparatus of the previous embodiment explained referring to FIGS. 1 to 6 except that the voltage changed in the frame after the image transition is independently controlled in a unit of a pixel of the display panel. Thus, the same reference numerals will be used to refer to the same or like parts as those described in the previous embodiment of FIGS. 1 to 6 and any repetitive explanation concerning the above elements will be omitted.

Referring to FIGS. 1, 3 to 6, 10 and 11, in the illustrated embodiment, the voltage (e.g., the bias voltage VOBS) applied to the driving switching element T1 and changed in the frame after the image transition may be independently applied in a unit of a pixel of the display panel 100. Although the voltage changed in the frame after the image transition is the bias voltage VOBS and the bias voltage VOBS is independently applied in a unit of the pixel in FIGS. 10 and 11, the inventive concept may not be limited thereto. The voltage changed in the frame after the image transition may be the data initialization voltage VINIT as shown in the embodiments of FIGS. 7A to 7C and the data initialization voltage VINIT may be independently applied in a unit of the pixel. The voltages changed in the frame after the image transition may be the bias voltage VOBS and the data initialization voltage VINIT as shown in the embodiments of FIGS. 8A to 8C and the bias voltage VOBS and the data initialization voltage VINIT may be independently applied in a unit of the pixel.

In FIG. 10, a pixel disposed in an N-th pixel row and an M-th pixel column may include first, second, third, fourth, fifth, sixth, seventh and eighth switching elements TIN, T2N, T3N, T4N, T5N, T6N, T7N and T8N, a storage capacitor CSTN and the light-emitting element EEN. Herein, N is a positive integer and M is a positive integer.

The pixel disposed in the N-th pixel row and the M-th pixel column receives a writing gate signal GW[N], a compensation gate signal GC[N], a data initialization gate signal GI[N], a bias gate signal GB[N], the data voltage VDATA[M] and the emission signal EM[N] and the light-emitting element EEN of the pixel emits light corresponding to the level of the data voltage VDATA[M] to display the image.

In FIG. 10, a pixel disposed in an N+1-th pixel row and the M-th pixel column may include first, second, third, fourth, fifth, sixth, seventh and eighth switching elements T1N+1, T2N+1, T3N+1, T4N+1, T5N+1, T6N+1, T7N+1 and T8N+1, a storage capacitor CSTN+1 and the light-emitting element EEN+1.

The pixel disposed in the N+1-th pixel row and the M-th pixel column receives a writing gate signal GW[N+1], a compensation gate signal GC[N+1], a data initialization gate signal GI[N+1], a bias gate signal GB[N+1], the data voltage VDATA[M] and the emission signal EM[N+1] and the light-emitting element EEN+1 of the pixel emits light corresponding to the level of the data voltage VDATA[M] to display the image.

In FIG. 11, a pixel disposed in an N-th pixel row and an M+1-th pixel column may include first, second, third, fourth, fifth, sixth, seventh and eighth switching elements T1N, T2N, T3N, T4N, T5N, T6N, T7N and T8N, a storage capacitor CSTN and the light-emitting element EEN.

The pixel disposed in the N-th pixel row and the M+1-th pixel column receives a writing gate signal GW[N], a compensation gate signal GC[N], a data initialization gate signal GI[N], a bias gate signal GB[N], the data voltage VDATA[M+1] and the emission signal EM[N] and the light-emitting element EEN of the pixel emits light corresponding to the level of the data voltage VDATA[M+1] to display the image.

In FIG. 11, a pixel disposed in an N+1-th pixel row and the M+1-th pixel column may include first, second, third, fourth, fifth, sixth, seventh and eighth switching elements T1N+1, T2N+1, T3N+1, T4N+1, T5N+1, T6N+1, T7N+1 and T8N+1, a storage capacitor CSTN+1 and the light-emitting element EEN+1.

The pixel disposed in the N+1-th pixel row and the M+1-th pixel column receives a writing gate signal GW[N+1], a compensation gate signal GC[N+1], a data initialization gate signal GI[N+1], a bias gate signal GB[N+1], the data voltage VDATA[M+1] and the emission signal EM[N+1] and the light-emitting element EEN+1 of the pixel emits light corresponding to the level of the data voltage VDATA[M+1] to display the image.

In the illustrated embodiment, an N-th bias voltage VOBS[N, M] may be applied to the eighth switching element TON of the pixel disposed in the N-th pixel row and the M-th pixel column and an N+1-th bias voltage VOBS[N+1, M] may be applied to the eighth switching element T8N+1 of the pixel disposed in the N+1-th pixel row and the M-th pixel column.

In the illustrated embodiment, an N-th bias voltage VOBS[N, M+1] may be applied to the eighth switching element TON of the pixel disposed in the N-th pixel row and the M+1-th pixel column and an N+1-th bias voltage VOBS[N+1, M+1] may be applied to the eighth switching element T8N+1 of the pixel disposed in the N+1-th pixel row and the M+1-th pixel column.

In the illustrated embodiment, the bias voltage VOBS is changed only for the pixel in which the image transition occurs so that a unit of hysteresis characteristic compensation of the driving switching element T1 may be subdivided into a unit of the pixel. In addition, the bias voltage VOBS of the pixel in which the image transition does not occur may not be changed so that an unexpected display defect due to the change of the bias voltage VOBS may be prevented.

In the illustrated embodiment, the voltage (e.g., the bias voltage VOBS and the data initialization voltage VINIT) applied to the driving switching element T1 may be changed in the frame (e.g., the fourth frame FR4 or the fourth to sixth frames FR4 to FR6) after the image transition so that the hysteresis characteristic of the driving switching element T1 may be compensated. Accordingly, the luminance decrease in the frame after the image transition may be prevented. Thus, the display quality of the display panel 100 may be enhanced.

In addition, the initialization operation of the driving switching element T1 and the threshold voltage compensation operation of the driving switching element T1 may not be repetitively performed so that the power consumption of the display apparatus may be reduced.

In addition, when the voltage (e.g., the bias voltage VOBS and the data initialization voltage VINIT) applied to the driving switching element T1 is changed in the frame after the image transition to compensate the hysteresis characteristic of the driving switching element T1, a variable frequency driving method may be easily applied to the display apparatus so that the power consumption of the display apparatus may be reduced by the variable frequency driving method.

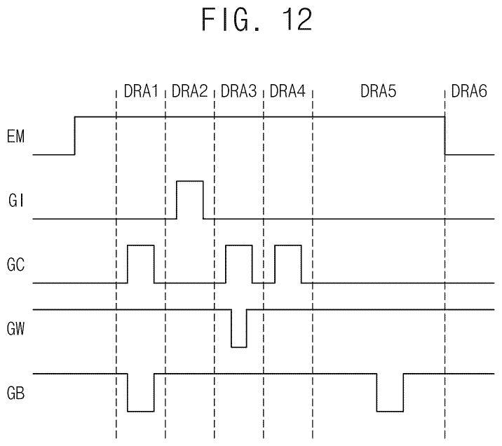

FIG. 12 is a timing diagram illustrating an embodiment of input signals applied to a pixel of a display apparatus according to the inventive concept.

The display apparatus in the illustrated embodiment is substantially the same as the display apparatus of the previous embodiment explained referring to FIGS. 1 to 6 except for the input signals applied to the pixel of the display apparatus. Thus, the same reference numerals will be used to refer to the same or like parts as those described in the previous embodiment of FIGS. 1 to 6 and any repetitive explanation concerning the above elements will be omitted.

Referring to FIGS. 1, 2, 4A to 6 and 12, the display panel 100 includes a plurality of pixels. Each pixel includes a light-emitting element EE.

The pixel receives a writing gate signal GW, a compensation gate signal GC, a data initialization gate signal GI, a bias gate signal GB, a data voltage VDATA and an emission signal EM and the light-emitting element EE of the pixel emits light corresponding to the level of the data voltage VDATA to display the image.

A driving timing of the pixel may include a first period DRA1, a second period DRA2, a third period DRA3, a fourth period DRA4, a fifth period DRA5 and a sixth period DRA6.

In the first period DRA1, the emission signal EM may have an inactive level, the data initialization gate signal GI may have an inactive level, the compensation gate signal GC may have an active pulse, the writing gate signal GW may have an inactive level and the bias gate signal GB may have an active pulse.

In the second period DRA2 subsequent to the first period DRA1, the emission signal EM may have the inactive level, the data initialization gate signal GI may have an active pulse, the compensation gate signal GC may have an inactive level, the writing gate signal GW may have the inactive level and the bias gate signal GB may have an inactive level.

In the third period DRA3 subsequent to the second period DRA2, the emission signal EM may have the inactive level, the data initialization gate signal GI may have the inactive level, the compensation gate signal GC may have an active pulse, the writing gate signal GW may have an active pulse and the bias gate signal GB may have the inactive level.

In the fourth period DRA4 subsequent to the third period DRA3, the emission signal EM may have the inactive level, the data initialization gate signal GI may have the inactive level, the compensation gate signal GC may have an active pulse, the writing gate signal GW may have the inactive level and the bias gate signal GB may have the inactive level.

In the fourth period DRA4, the third switching element T3 may be turned on in response to the compensation gate signal GC so that the first node N1 and the third node N3 may be connected to each other.

In the fifth period DRA5 subsequent to the fourth period DRA4, the emission signal EM may have the inactive level, the data initialization gate signal GI may have the inactive level, the compensation gate signal GC may have the inactive level, the writing gate signal GW may have the inactive level and the bias gate signal GB may have an active pulse.

In the sixth period DRA6 subsequent to the fifth period DRA5, the emission signal EM may have an active level, the data initialization gate signal GI may have the inactive level, the compensation gate signal GC may have the inactive level, the writing gate signal GW may have the inactive level and the bias gate signal GB may have the inactive level.

In the illustrated embodiment, the voltage (e.g., the bias voltage VOBS and the data initialization voltage VINIT) applied to the driving switching element T1 may be changed in the frame (e.g., the fourth frame FR4 or the fourth to sixth frames FR4 to FR6) after the image transition so that the hysteresis characteristic of the driving switching element T1 may be compensated. Accordingly, the luminance decrease in the frame after the image transition may be prevented. Thus, the display quality of the display panel 100 may be enhanced.

In addition, the initialization operation of the driving switching element T1 and the threshold voltage compensation operation of the driving switching element T1 may not be repetitively performed so that the power consumption of the display apparatus may be reduced.

In addition, when the voltage (e.g., the bias voltage VOBS and the data initialization voltage VINIT) applied to the driving switching element T1 is changed in the frame after the image transition to compensate the hysteresis characteristic of the driving switching element T1, a variable frequency driving method may be easily applied to the display apparatus so that the power consumption of the display apparatus may be reduced by the variable frequency driving method.

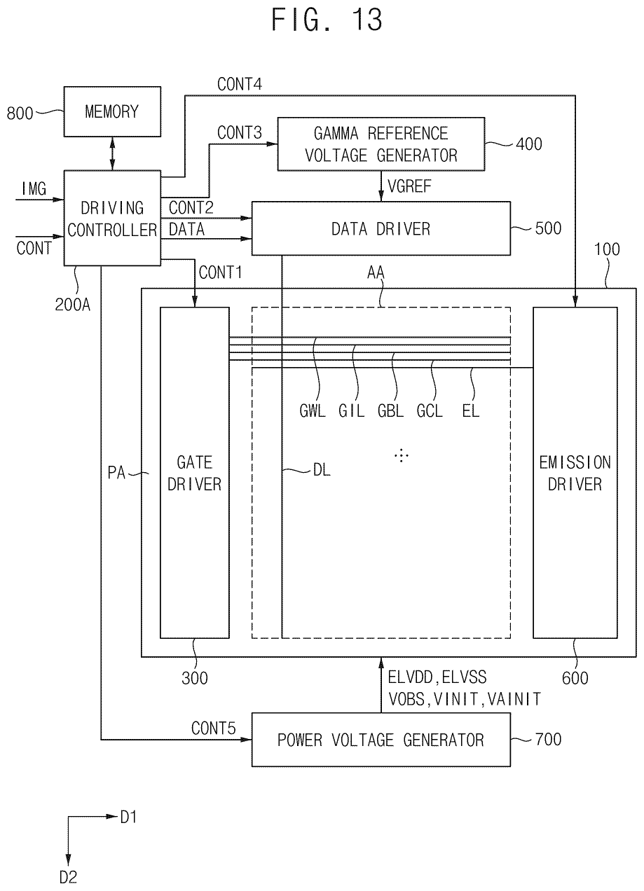

FIG. 13 is a block diagram illustrating an embodiment of a display apparatus according to the inventive concept.

The display apparatus in the illustrated embodiment is substantially the same as the display apparatus of the previous embodiment explained referring to FIGS. 1 to 6 except for an operation of determining an image transition of a display panel driver. Thus, the same reference numerals will be used to refer to the same or like parts as those described in the previous embodiment of FIGS. 1 to 6 and any repetitive explanation concerning the above elements will be omitted.

Referring to FIGS. 2 to 6 and 13, the display apparatus includes a display panel 100 and a display panel driver. The display panel driver includes a driving controller 200A, a gate driver 300, a gamma reference voltage generator 400, a data driver 500 and an emission driver 600. The display panel driver may further include a power voltage generator 700. In the illustrated embodiment, the display panel driver may further include a memory 800.

The display panel driver determines an image transition of a display image of the display panel 100. When the image transition occurs, the display panel driver may change a voltage applied to the driving switching element T1 in a frame after the image transition.

In the illustrated embodiment, the display panel driver may determine the image transition by comparing a previous frame image and a current frame image. In an embodiment, the processor may output the input image data IMG to the display panel driver regardless of whether the current input image is the same as the previous input image or not, for example.

Accordingly, in the illustrated embodiment, when the display panel driver receives an image from the processor, it may not mean that the image transition occurs. Instead, the display panel driver may compare the previous frame image and the current frame image. When the previous frame image and the current frame image are different from each other, the display panel driver may determine the image transition.

In an embodiment, the previous frame image and the current frame image may be stored in the memory 800, for example. The driving controller 200A may communicate with the memory 800 to compare the previous frame image and the current frame image.

In the illustrated embodiment, the display panel driver may increase the bias voltage VOBS applied to the first electrode of the driving switching element T1 in a frame after the image transition.

In an alternative embodiment, the display panel driver may decrease the data initialization voltage VINIT applied to the control electrode of the driving switching element T1 in the frame after the image transition.

In an alternative embodiment, the display panel driver may increase the bias voltage VOBS applied to the first electrode of the driving switching element T1 and decrease the data initialization voltage VINIT applied to the control electrode of the driving switching element T1 in the frame after the image transition.

In the illustrated embodiment, the voltage (e.g., the bias voltage VOBS and the data initialization voltage VINIT) applied to the driving switching element T1 may be changed in the frame (e.g., the fourth frame FR4 or the fourth to sixth frames FR4 to FR6) after the image transition so that the hysteresis characteristic of the driving switching element T1 may be compensated. Accordingly, the luminance decrease in the frame after the image transition may be prevented. Thus, the display quality of the display panel 100 may be enhanced.

In addition, the initialization operation of the driving switching element T1 and the threshold voltage compensation operation of the driving switching element T1 may not be repetitively performed so that the power consumption of the display apparatus may be reduced.

In addition, when the voltage (e.g., the bias voltage VOBS and the data initialization voltage VINIT) applied to the driving switching element T1 is changed in the frame after the image transition to compensate the hysteresis characteristic of the driving switching element T1, a variable frequency driving method may be easily applied to the display apparatus so that the power consumption of the display apparatus may be reduced by the variable frequency driving method.

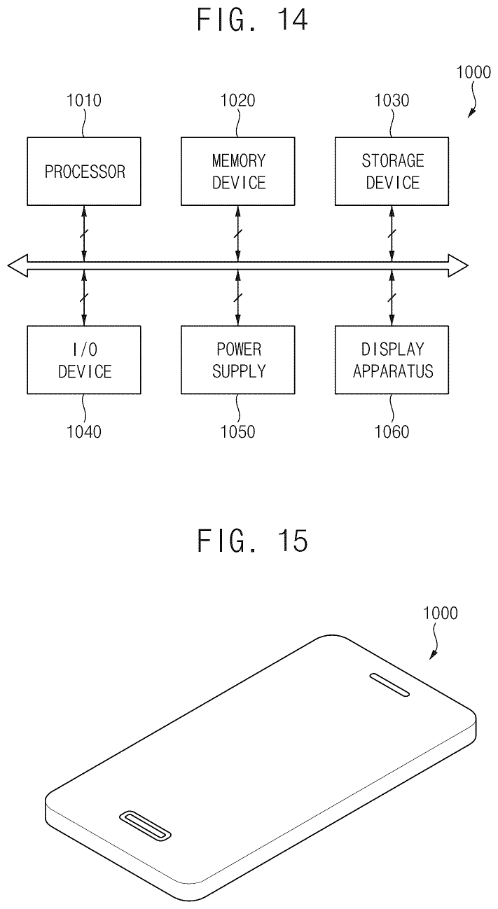

FIG. 14 is a block diagram illustrating an embodiment of an electronic apparatus 1000 according to the inventive concept. FIG. 15 is a diagram illustrating an embodiment in which the electronic apparatus 1000 of FIG. 14 is implemented as a smartphone.

Referring to FIGS. 14 and 15, the electronic apparatus 1000 may include a processor 1010, a memory device 1020, a storage device 1030, an input/output (“I/O”) device 1040, a power supply 1050, and a display apparatus 1060. Here, the display apparatus 1060 may be the display apparatus of FIG. 1 or FIG. 13. In addition, the electronic apparatus 1000 may further include a plurality of ports for communicating with a video card, a sound card, a memory card, a universal serial bus (“USB”) device, other electronic apparatuses, etc.

In an embodiment, as illustrated in FIG. 15, the electronic apparatus 1000 may be implemented as a smartphone. However, the electronic apparatus 1000 is not limited thereto. In an embodiment, the electronic apparatus 1000 may be implemented as a television, a monitor, a cellular phone, a video phone, a smart pad, a smart watch, a tablet personal computer (“PC”), a car navigation system, a laptop, a head disposed (e.g., mounted) display (“HMD”) device, or the like, for example.

The processor 1010 may perform various computing functions or various tasks. The processor 1010 may be a micro-processor, a central processing unit (“CPU”), an application processor (“AP”), or the like. The processor 1010 may be coupled to other components via an address bus, a control bus, a data bus, etc. Further, the processor 1010 may be coupled to an extended bus such as a peripheral component interconnection (“PCI”) bus.

The processor 1010 may output the input image data IMG and the input control signal CONT to the driving controller 200 of FIG. 1. The processor 1010 may also be also referred to as a host, an application processor or a television set.

The memory device 1020 may store data for operations of the electronic apparatus 1000. In an embodiment, the memory device 1020 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like and/or at least one volatile memory device such as a dynamic random access memory (“DRAM”) device, a static random access memory (“SRAM”) device, a mobile DRAM device, or the like, for example.

The storage device 1030 may include a solid state drive (“SSD”) device, a hard disk drive (“HDD”) device, a compact disc read-only memory (“CD-ROM”) device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

By the embodiments of the display apparatus and the electronic apparatus including the display apparatus, the display quality of the display panel may be enhanced and the power consumption of the display apparatus may be reduced.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the illustrative embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display apparatus comprising:
a display panel including a pixel including:
a light-emitting element; and
a driving switching element; and
a display panel driver configured to determine an image transition of a display image of the display panel and configured to change a voltage applied to the driving switching element in a frame after the image transition in a state in which the image transition occurs.

2. The display apparatus of claim 1, wherein the driving switching element includes:
a control electrode connected to a first node;
a first electrode connected to a second node; and
a second electrode connected to a third node,
wherein the pixel further includes:
a writing switching element including:
a control electrode configured to receive a writing gate signal;
a first electrode configured to receive a data voltage; and
a second electrode connected to the second node; and
a bias switching element including:
a control electrode configured to receive a bias gate signal;
a first electrode configured to receive a bias voltage; and
a second electrode connected to the second node, and
wherein the display panel driver is configured to increase the bias voltage applied to the first electrode of the driving switching element in the frame after the image transition.

3. The display apparatus of claim 2, wherein the display panel driver is configured to increase the bias voltage applied to the first electrode of the driving switching element in one frame after the image transition.

4. The display apparatus of claim 2, wherein the display panel driver is configured to increase the bias voltage applied to the first electrode of the driving switching element in plural consecutive frames after the image transition.

5. The display apparatus of claim 4, wherein a first increase of the bias voltage in a first frame after the image transition is greater than a second increase of the bias voltage in a second frame after the image transition.

6. The display apparatus of claim 1, wherein the pixel further includes:
a data initialization switching element including:
a control electrode configured to receive a data initialization gate signal;
a first electrode configured to receive a data initialization voltage; and
a second electrode connected to a control electrode of the driving switching element, and
wherein the display panel driver is configured to decrease the data initialization voltage applied to the control electrode of the driving switching element in the frame after the image transition.

7. The display apparatus of claim 6, wherein the display panel driver is configured to decrease the data initialization voltage applied to the control electrode of the driving switching element in one frame after the image transition.

8. The display apparatus of claim 6, wherein the display panel driver is configured to decrease the data initialization voltage applied to the control electrode of the driving switching element in plural consecutive frames after the image transition.

9. The display apparatus of claim 8, wherein a first decrease of the data initialization voltage in a first frame after the image transition is greater than a second decrease of the data initialization voltage in a second frame after the image transition.

10. The display apparatus of claim 1, wherein the driving switching element includes a P-type transistor, and
wherein the pixel further includes a data initialization switching element including an N-type transistor.

11. The display apparatus of claim 1, wherein the driving switching element includes:
a control electrode connected to a first node;
a first electrode connected to a second node; and
a second electrode connected to a third node,
wherein the pixel further includes:
a writing switching element including:
a control electrode configured to receive a writing gate signal;
a first electrode configured to receive a data voltage; and
a second electrode connected to the second node;
a bias switching element including:
a control electrode configured to receive a bias gate signal;
a first electrode configured to receive a bias voltage; and
a second electrode connected to the second node; and
a data initialization switching element including:
a control electrode configured to receive a data initialization gate signal;
a first electrode configured to receive a data initialization voltage; and
a second electrode connected to the first node, and
wherein the display panel driver is configured to increase the bias voltage applied to the first electrode of the driving switching element and decrease the data initialization voltage applied to the control electrode of the driving switching element in the frame after the image transition.

12. The display apparatus of claim 11, wherein the display panel driver is configured to increase the bias voltage applied to the first electrode of the driving switching element and decrease the data initialization voltage applied to the control electrode of the driving switching element in one frame after the image transition.

13. The display apparatus of claim 11, wherein the display panel driver is configured to increase the bias voltage applied to the first electrode of the driving switching element and decrease the data initialization voltage applied to the control electrode of the driving switching element in plural consecutive frames after the image transition.

14. The display apparatus of claim 13, wherein a first increase of the bias voltage in a first frame after the image transition is greater than a second increase of the bias voltage in a second frame after the image transition, and
wherein a first decrease of the data initialization voltage in the first frame after the image transition is greater than a second decrease of the data initialization voltage in the second frame after the image transition.

15. The display apparatus of claim 1, wherein the pixel is provided in plural, and
the voltage applied to the driving switching element and changed in the frame after the image transition is commonly applied to all of pixels of the display panel.

16. The display apparatus of claim 1, wherein the voltage applied to the driving switching element and changed in the frame after the image transition is independently applied in a unit of a pixel row of the display panel.

17. The display apparatus of claim 1, wherein the voltage applied to the driving switching element and changed in the frame after the image transition is independently applied in a unit of the pixel of the display panel.

18. The display apparatus of claim 1, wherein in a state in which the display panel driver receives an updated image, the display panel driver is configured to determine the image transition.

19. The display apparatus of claim 1, wherein the display panel driver is configured to determine the image transition by comparing a previous frame image and a current frame image.

20. An electronic apparatus comprising:
a display panel including a pixel including:
a light-emitting element; and
a driving switching element;
a display panel driver configured to determine an image transition of a display image of the display panel and configured to change a voltage applied to the driving switching element in a frame after the image transition in a state in which the image transition occurs; and
a processor configured to output input image data and an input control signal to the display panel driver.
